(19) United States
(12) Patent Application Publication
(10) Pub. No.: US 2017/0084007 A1
(43) Pub. Date: Mar. 23, 2017

(54) TIME-SPACE METHODS AND SYSTEMS FOR THE REDUCTION OF VIDEO NOISE

(71) Applicant: WRNCH INC., Montréal (CA)

(72) Inventors: Meisam Rakhshanfar, Montreal (CA); Maria Aishy Amer, Montreal (CA)

(21) Appl. No.: 15/311,433

(22) PCT Filed: May 15, 2015
(86) PCT No.: PCT/CA2015/000323

§ 371 Date: Nov. 15, 2016

Related U.S. Application Data
(60) Provisional application No. 61/993,884, filed on May 15, 2014.

(51) Int. Cl. G06T 5/00; G06T 5/20; G06T 5/50

(52) U.S. Cl. CPC G06T 5/002; G06T 5/50; G06T 5/20; G06T 2207/10016; G06T 2207/20182

(57) ABSTRACT

A time-space domain video denoising method is provided which reduces video noise of different types. Noise is assumed to be real-world camera noise such as white Gaussian noise (signal-independent), mixed Poissonian-Gaussian (signal-dependent) noise, or processed (non-white) signal-dependent noise. This method comprises the following processing steps: 1) time-domain filtering on current frame using motion-compensated previous and subsequent frames; 2) restoration of possibly blurred contents due to faulty motion compensation and noise estimation; 3) spatial filtering to remove residual noise left from temporal filtering. To reduce the blocking effect, a method is applied to detect and remove blocking in the motion compensated frames. To perform time-domain filtering weighted motion-compensated frame averaging is used. To decrease the chance of blurring, two levels of reliability are used to accurately estimate the weights.

### RELATED APPLICATIONS

This application claims priority to U.S. Patent Application No. 61/993,884, filed May 15, 2014, titled “Time-Space Method and System for the Reduction of Video Noise”, the entire contents of which are hereby incorporated by reference.

### TECHNICAL FIELD

The following invention or inventions generally relate to image and video noise analysis and specifically to the reduction of video noise.

### DESCRIPTION OF THE RELATED ART

Modern video capturing devices often introduce random noise and video denoising is still an important feature for video systems. Many video denoising approaches are known to restore videos that have been degraded by random noise. Recent advances in denoising have achieved remarkable results [Reference 1]-[Reference 9], however, the simplicity of their noise source modeling makes them impractical for real-world video noise. Mostly, noise is assumed a) to be zero-mean additive white Gaussian and b) accurately pre-estimated. However, in practice noise can be over or underestimated, signal-dependent (Poissonian-Gaussian), or frequency-dependent (processed).

The assumption that the noise is uniformly distributed over the whole frame, causes motion and smoothing blur in the regions where motion vectors and noise level differs from reality, since noise and image structure are mistaken. Additional issues of recent video denoising methods is that they are computationally expensive such as [Reference 2], [Reference 4], and very few handle color video denoising.

Accuracy of motion vectors has an important impact on the performance of temporal filters. In fact, the quality of motion estimation determines the quality of motion-based video denoising. Many motion estimation methods [Reference 10]-[Reference 16] have been developed for different applications such as video coding, stabilization, enhancement and deblurring. Based on the application the priority can be the speed or the accuracy. For enhancement applications the inaccuracy of motion vectors (MVs) can be compensated by the error detection such as in [Reference 17], [Reference 18].

Accordingly, the above issues affect the way in which the noise is estimated in video and the way in which motion is estimated.

It will be appreciated that the references described herein using square brackets are listed below in full detail under the heading “References”.

### BRIEF DESCRIPTION OF THE DRAWINGS

Embodiments of the invention or inventions are described, by way of example only, with reference to the appended drawings wherein:

FIG. 1 shows examples of white noise versus processed noise.

FIG. 2 is an example embodiment of a computing system.

FIG. 3 is an example embodiment of modules of in a time-space video filter.

FIG. 4 is an example overview block diagram illustrating the time-space video filter.

FIG. 5 is an example block diagram illustrating the temporal frame combining module.

FIG. 6 is an example of data stored in a motion vectors bank.

FIGS. 7(a) and 7(b) illustrate block-matching before and after deblocking.

FIGS. 8(a) and 8(b) illustrate a comparison before homography creation and after homography creation.

FIGS. 9(a) and 9(b) compare the effects of denoising using a video with complex motion and using a video with small motion.

FIG. 10 is a table showing the PSNR (dB) comparison between VBM3D and MHMCF using the mean squared error of two video sets.

FIGS. 11(a), 11(b), 11(c) and 11(d) are examples of quality comparison for the original frame, a noisy frame with PSNR=25 dB, noise reduced by the proposed method, and noise reduced by MHMCF, respectively between the proposed method and MHMCF.

FIG. 12 is a table showing the PSNR (dB) comparison under signal-dependent noise condition using the mean squared error of 50 frames.

FIG. 13 is a table showing the PSNR (dB) comparison under colored signal-dependent noise condition using the mean squared error of 50 frames.

FIG. 14 shows example MetricQ Results for an in-to-tree sequence (top) and for a bgleft sequence (bottom).

FIG. 15 shows example quality index values for an in-to-tree sequence.

FIGS. 16(a)-16(d) show a motion blur comparison between the proposed method and MHMCF in part of an in-to-tree frame.

FIGS. 17(a)-17(b) show a motion blur comparison between the proposed method and MHMCF using different parameters.

FIGS. 18(a)-18(c) show a motion blur comparison in part of in-to-tree frame.

### DETAILED DESCRIPTION

It will be appreciated that for simplicity and clarity of illustration, in some cases, reference numerals may be repeated among the figures to indicate corresponding or analogous elements. In addition, some details or features are set forth to provide a thorough understanding of the embodiments described herein. However, it will be understood by those of ordinary skill in the art that the embodiments described herein are illustrative examples that may be practiced without these details or features. In other instances, well-known methods, procedures and components have not been described in detail so as not to obscure the invention illustrated in the examples described herein. Also, the description is not to be considered as limiting the scope of the example embodiments described herein or illustrated in the drawings.

It is herein recognized that it is desirable to have a multi-level video denoising method and system that automatically handles three types of noise: additive white Gaussian noise, Poissonian-Gaussian noise, and processed Poissonian-Gaussian noise. It is also herein recognized that it is desirable to have a multi-level video denoising method and system that operates in luma and chroma channels. It is also herein recognized that it is desirable to have a multi-level video denoising method and system that handles in-loop possible noise overestimation to decrease the chance of motion blur. It is also herein recognized that it is desirable to have a multi-level video denoising method and system that uses two-level reliability measures of estimated motion and noise in order to calculate weights in temporal filter. It is also herein recognized that it is desirable to have a multi-level video denoising method and system that estimates motion vectors through a fast multi-resolution motion estimation and correct the erroneous motion vectors by creating a homography from reliable motion vectors. It is also herein recognized that it is desirable to have a multi-level video denoising method and system that detects and eliminates possible motion blur and blocking artifacts. It is also herein recognized that it is desirable to have a multi-level video denoising method and system that uses a fast dual (pixel-transform) domain spatial filter to estimate and remove residual noise of the temporal filter. It is also herein recognized that it is desirable to have a multi-level video denoising method and system that uses a fast chroma-components UV denoising by using the same frame-averaging weights from luma Y component and block-level and pixel-level UV motion deblur.

The proposed systems and methods improve or extend upon the concepts of [Reference 19]. However, in comparison, the systems and methods described herein give a solution for a color video denoising. Furthermore, the systems and methods described herein handle both processed and white noise. Furthermore, the systems and methods described herein integrate a spatial filter in order to remove residual noise. Furthermore, the systems and methods described herein detect and remove artifacts due to blocking and motion blur.

In particular, a new time-space domain video denoising method is provided which reduces video noise of different types. This method comprises the following processing steps: 1) time-domain filtering on current frame using motion-compensated previous and subsequent frames; 2) restoration of possibly blurred contents due to faulty motion compensation and noise estimation; 3) spatial filtering to remove residual noise left from temporal filtering. To reduce the blocking effect, a method is applied to detect and remove blocking in the motion compensated frames. To perform time-domain filtering weighted motion-compensated frame averaging is used.

In another aspect of the proposed systems and methods, to decrease the chance of blurring, two levels of reliability are used to accurately estimate the weights. At the first level, temporal data blocks are used to coarsely detect errors in estimation of both motion and noise. Then at a finer level, weights are calculated utilizing fast convolution operations and likelihood functions. The computing system estimates motion vectors through a fast multiresolution motion estimation and correct the erroneous motion vectors by creating a homography from reliable motion vectors.

In another aspect, the proposed methods and systems include a fast dual (pixel-transform) domain spatial filter that is used to estimate and remove residual noise of the temporal filter.

In another aspect, the proposed methods and systems include fast chroma-components UV denoising by using the same frame-averaging weights from luma Y component and block-level and pixel-level UV motion deblur.

Simulation results show that the proposed method outperforms, both in accuracy and speed, related noise reduction works under white Gaussian, Poissonian-Gaussian, and processed non-white noise.

### 1. NOISE MODELLING

Video noise is signal-dependent due to physical properties of sensors and frequency-dependent due to post-capture processing (often in form of spatial filters). Video noise may be classified into: additive white Gaussian noise (AWGN), both frequency and signal independent; Poissonian-Gaussian noise (PGN), frequency-independent but signal-dependent (e.g. AWGN for a certain intensity); and processed Poissonian-Gaussian noise (PPN), both frequency and signal dependent, (e.g. non-white Gaussian for a particular intensity).

It is assumed that noise is added to the observed video frame Fₜ at time t as in,

Fₜ=Fₜ^{org}+nₒ;nₒ=σₒ²Θ(Fₜ^{org}) (1)

where Fₜ^{org} is the frame before noise contamination, σₒ² is the frame-representative variance of the input AWGN, PGN, or PPN in Fₜ, and Θₒ(.)=σₒ²Θ(.) is the noise level function (NLF) describing the noise variation relative to frame intensity.

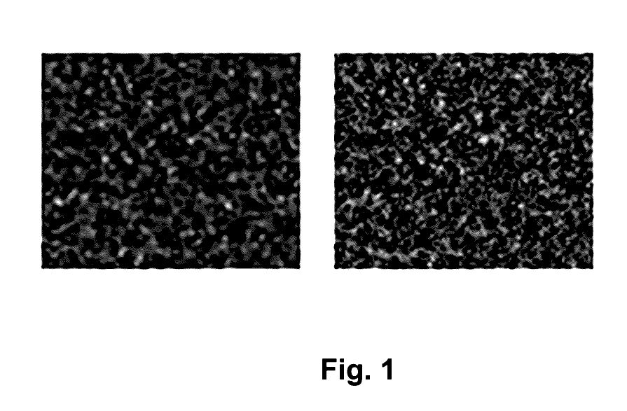

In a video capturing pipeline, independent and identically distributed frequency components of AWGN can be destroyed by built-in filters in video codecs or cameras. As a result, noise become frequency-dependent (processed). Since these built-in filters are designed to work in real-time to reduce the bit-rate using limited hardware resources, they are not designed to completely remove the noise. However, using bit-rate adaptive processing, they remove high-frequency (HF) noise and leave undesired low-frequency (LF) noise. For example, FIG. 1 shows white versus processed noise. The left side of FIG. 1 is a part of a frame from real-world video which in manipulated in the capturing pipeline. The right side of FIG. 1 is approximately equivalent to white Gaussian noise.

It is assumed that the HF signal of an image is represented in fine (or high) image resolution and the LF signal is represented in coarse (or low) image resolution. In an example embodiment of the proposed systems and methods, the finest resolution is the pixel-level and the coarsest resolution is the block level.

To reduce the bit-rate, in-camera algorithms remove the HF since most of the entropy is taken by HF. Thus, noise becomes spatially correlated more in finer resolutions and less in coarser. As a result, statistical properties of noise become very different compared to coarse level. Thus, unlike white noise, one value for noise variance σₒ² is not enough to model the PPN. Therefore, in the model of the proposed system and method, two noise variances are used: one σₚ² for the finest (pixel) level and one σ_{b}² for the coarsest (block) level.

Some in-camera filters (e.g., edge-stopping) remove only weak HF and keep the powerful HF. To remove such HF noise, original (unprocessed) noise variance σₒ² should be fed into noise reduction method as a pixel-level noise. When the processing is heavy, i.e., the HF elements of noise are suppressed entirely, feeding σₒ² to denoiser as a pixel-level will over-blur. Therefore, it is herein considered that σₚ²≦σₒ² is the appropriate noise level to remove remaining HF. If we have a signal-free (pure noise) image, the pixel-level noise is the variance of pixel intensities contaminated with powerful HF noise, and block-level noise is the variance of mean of non-overlapped blocks.

L is defined as the length of block dimensions in pixels, σₚ² as the pixel-level noise and σ_{b}² as the block-level noise. It is assumed that σₒ², σₚ², and σ_{b}² are provided by a noise estimator before denoising. It is assumed processing does not affect the block-level noise of all types and

$${σ}_{b} = \frac{{σ}_{o}}{L} .$$

In case of white noise

$${σ}_{p}^{2} = {σ}_{o}^{2}$$

$$and$$

$${σ}_{b} = \frac{{σ}_{p}}{L}$$

and in case of processed noise

$${σ}_{b} > \frac{{σ}_{p}}{L} .$$

It is also assumed processing does not affect the NLF Θₒ(.). Under PPN, the method proposed herein assumes that the degree (power) of processing on the original PGN variance σₒ² is not large; meaning the nature of PGN was not heavily changed.

To address signal-dependent noise, it is assumed its NLF is pre-estimated. It is assumed the shape of noise variation (e.g. the NLF) does not change after built-in-camera processing and both σₚ and σ_{b} are extracted from the same intensity. For example, if σₚ² represents the pixel-level noise at intensity I, σ_{b}² also represents block-level noise at intensity I. Therefore, the variation of noise over the intensity in pixel level and block-level can be modeled as Θₚ(.)=σₚ²Θ(.) and Θ_{b}(.)=σ_{b}²Θ(.), respectively.

In case of signal-independent noise (e.g., Gaussian) Θ(.)=1 and in case of white Gaussian Θ(.)=1 and

$${σ}_{b} = \frac{{σ}_{p}}{L}$$

In color video denoising, it is assumed σₚ² and σ_{b}² are associated to luma channel (Y). And for chroma channels (U and V), σ_{pU}², σ_{bU}², σ_{pV}², and σ_{bV}² are defined as the pixel and block level noise in U and V channels. For simplicity of design, it is assumed that there is no signal-dependency in chroma channels, that is Θ(.)=1.

### 2. STATE OF THE ART

This section relates to known methods to provide additional context to the proposed systems and methods. It also herein recognized that there may be problems or drawbacks associated with these known methods.

Video denoising methods can be classified based on two criteria: 1) how the temporal information is fed into filter; and 2) what domain (e.g., transform or pixel) the filter use. According to the first criterion, filters can be classified into two categories: filters that operate on the original frames (prior and posterior) [Reference 2], [Reference 4], [Reference 6], [Reference 7] and recursive temporal filter (RTF), that use already filtered frames [Reference 17], [Reference 20], [Reference 21]. Although, feedback in the structure of RTF makes them fast, it is herein recognized that the assumption that the filtered frame is noise free, makes the error propagate in time.

The second criterion divides filters into transform or pixel domain. Many high performance transform (e.g., Wavelet or DCT) domain methods [Reference 2]-[Reference 9], [Reference 20] have been introduced to achieve a sparse representation of the video signal. The high performance video denoising algorithm VBM3D [Reference 4] groups a 3-D data array which is formed by stacking together blocks found similar to the currently processed one. A recently advanced VBM3D [Reference 7] goes a step further by proposing the VBM4D which stacks similar 3-D spatio-temporal volumes instead of 2-D blocks to form four-dimensional (4-D) data arrays. In [Reference 2], based on the spatio-temporal Gaussian scale mixture (ST-GSM) model, local correlation between the wavelet coefficients of noise-free video sequences across both space and time is captured. Then the Bayesian least square estimation is applied to accomplish the video denoising. It is herein recognized that computation of these methods is costly. Moreover, the noise model is oversimplified which makes them unsuitable for real world applications, such as applications in consumer electronics.

Pixel-domain video filtering approaches [Reference 17], [Reference 18]. [Reference 21]-[Reference 28], utilizing motion estimation techniques, are generally faster by performing pixel-level operations. In such methods, a 3-D window of a large blocks or small patches along the temporal axis or the estimated motion trajectory is utilized for the linear filtering of each pixel value. Their challenge is how to take spatial information into account. It is herein recognized that first class does not take spatial information into account and the second class supports the temporal filter with a spatial filter. The first class contains pure temporal filters. Although the approaches [Reference 18], [Reference 25] do not use spatial information have simple and fast pipeline, it is herein recognized that the residual noise, however, makes the noise reduction inconsistent over the frame especially in complex motion.

Multi-hypothesis motion-compensated filter (MHMCF) presented in [Reference 25] uses linear minimum mean squared error (LMMSE) of non-overlapping block to calculate the averaging weights. Its coarse (low-resolution) estimation of error using large blocks (e.g., 16×16), leads to motion blur and blocking artifacts in complex motion. [Reference 29] applies MHMCF to color video denoising, where the video denoising is performed in a noise adaptive color space different from traditional YUV color space. This leads to a more accurate estimation, however, it herein recognized that due to chroma subsampling in codecs, noise adaptive color space is not realistic in many applications. [Reference 21] used the same scheme of color conversion in [Reference 29] but all channels are taken into account to increase the reliability of weight estimation.

[Reference 18] simplifies the temporal motion to global camera motion. They perform the denoising by estimating the homography flow and applying the temporal aggregation using the multi-scale fusion. The second class of pixel-domain video filters uses spatial filters when the temporal information is not reliable. In [Reference 27] hard decision is used to combine temporal and bilateral filter. Computational costly non-local mean is used in [Reference 28] by employing random K-nearest neighbor blocks where temporal and spatial blocks are treated in the same way. Authors of [Reference 26] used the complex BM3D [Reference 30] filter as the spatial support. [Reference 31] combined the outputs of wavelet-based local Wiener and adaptive bilateral filtering to be used as the backup spatial filter.

Related methods handle mostly AWGN. Video denoising under PGN or PPN is not much of an active research. In [Reference 28], noise is assumed to be structured (frequency-dependent) but uniformly distributed (signal-independent). MVs also are assumed to be reliable.

Motion estimation is an essential part of most pixel-domain noise reduction methods. It is herein recognized that optical flow motion estimation methods [Reference 10], [Reference 32] are slow, have problems in large motions, and their performance decreases under noise.

Block matching methods such as diamond search (DS) [Reference 33]-[Reference 35], three step search (3SS) [Reference 11], and four step search (4SS) [Reference 12] have been widely used. They are faster compared to optical flow and more robust to noise compared to other types of motion estimation algorithms. However, it is herein recognized that they are likely to fall into local minima. They find a block which is most similar to a current block within a predefined search area in a reference frame.

Multiresolution motion estimation algorithms (MMEA) start with an initial coarse estimation and then refine it. They are efficient in both small and large motions since MV candidates are obtained from the coarse levels and the candidate becomes the search center of the next level. It is recognized herein that the problem of these methods is that the error propagates into finer levels when estimation falls into a local minima in a coarse level. Therefore, a procedure to detect the failures and compensate them is desirable, as addressed in the proposed systems and methods described herein.

### 3. TIME-SPACE VIDEO FILTERING

The following provides example embodiments for a method and a system for reduction of video noise and preferably based upon the detection of motion vector errors and of image blurs.

3.1 Overview

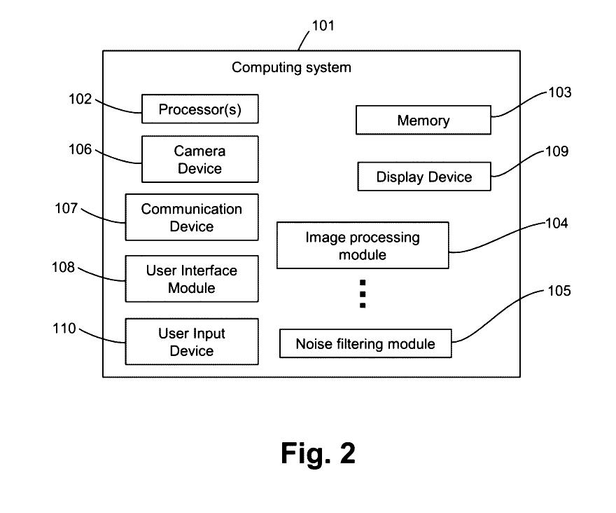

It will be appreciated that a computing system is configured to perform the methods described herein. As shown in FIG. 2, an example computing system or device 101 includes one or more processor devices 102 configured to execute the computations or instructions described herein. The computing system or device also includes memory 103 that stores the instructions and the image data. Software or hardware modules, or combinations of both, are also included. For example, an image processing module 104 is configured to manipulate and transform the image data. The noise filtering module 105 is configured to facilitate motion-compensated and deblocked frame averaging, detection of faulty noise variance and motion vectors, and spatial pixel-transform filtering.

The computing system may include, though not necessarily, other components such as a camera device 106, a communication device 107 for exchanging data with other computing devices, a user interface module 108, a display device 109, and a user input device 110.

The computing system may include other components and modules that are not shown in FIG. 2 or described herein.

In a non-limiting example embodiment, the computing system or device 101 is a consumer electronics device with a body that houses components, such as a processor, memory and a camera device. Non-limiting examples of electronic devices include mobile devices, camera devices, camcorder devices, and tablets.

The computing system is configured to perform the following three main operations: motion-compensated and deblocked frame averaging; detection of faulty noise variance and motion vectors; and spatial pixel transform filtering.

The first step linearly averages reference frame and motion-compensated frames from prior and following times. To provide motion-compensated frames, motion estimation along reference frame and frames inside a predefined temporal window is accomplished and then a deblocking approach is applied on motion-compensated frames to reduce possible blocking artifacts from block-based motion estimation. A coarse analysis of estimation errors delivers information about accuracy of motion vectors (MVs) and noise. Based on this information, at a finer level, averaging weights are calculated to accomplish the temporal time domain denoising.

In the second processing step, probable motion blurs caused by faulty estimated MVs and faulty estimated noise variances are detected and corrected through a restoration process. Due to limitations in temporal processing such as small size of temporal window and erroneous motion vectors, noise cannot be fully removed.

At the third processing step, residual noise from the temporal filter is estimated and removed utilizing spatial information of reference frame. A fast dual-domain filter is herein proposed.

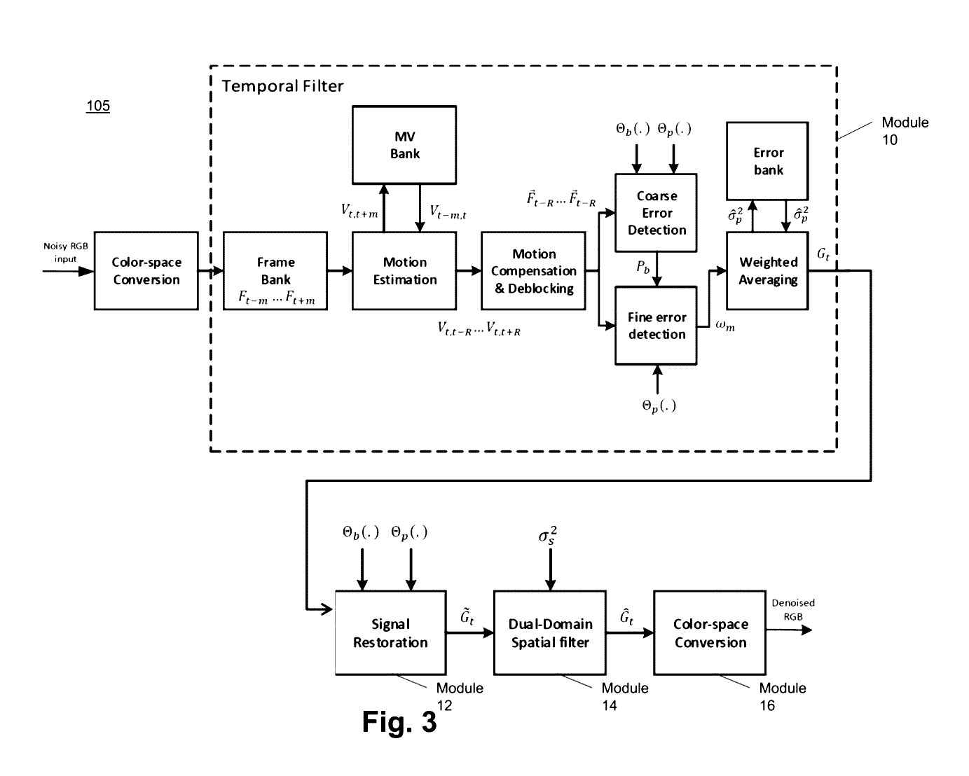

FIG. 3 shows example module components of a noise filter, which is implemented as part of the computing system 101. The temporal filter module 10 includes a frame bank, a motion estimator, an MV bank, a motion compensator and deblocker, a coarse error detector, a fine error detector, an error bank, and a weighted averaging module. Module 10 is in communication with a signal restoration module 12. The output from module 12 is used by a dual-domain spatial filter module 14. The output from module 14 is used by a color-space conversion module 16.

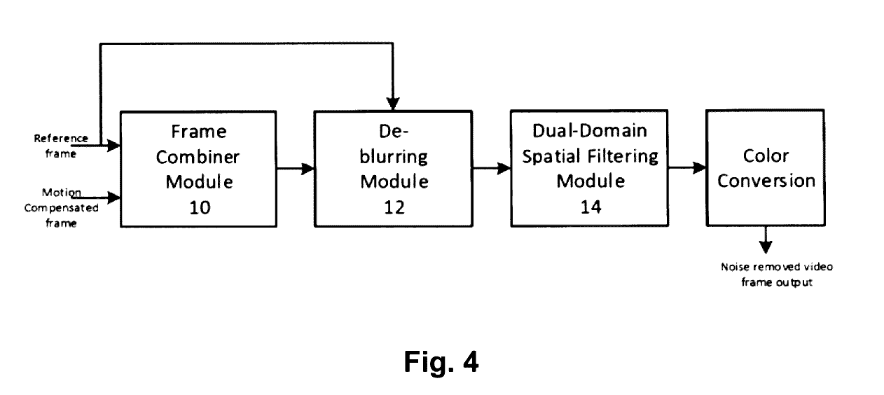

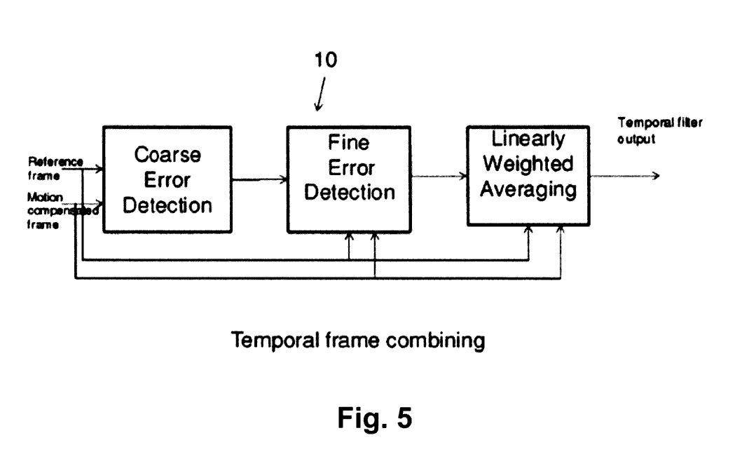

Referring to FIGS. 3, 4 and 5, a coarse analysis of estimation errors delivers information about the accuracy of the estimation in motion vectors and noise. Based on this accuracy, at a finer level, averaging weights are calculated to accomplish temporal time-domain denoising. Due to limitations in temporal processing, such as the small size of temporal window and the erroneousness of motion estimation, noise cannot be fully removed. In the second processing step, faulty estimated motion vectors and faulty estimated noise variances and associated motion blurs are detected and corrected through deblurring using a likelihood function of motion blur shown as the deblurring module 12. At the third processing step, residual noise from the temporal filter (e.g. module 10) is removed by utilizing a dual-domain (i.e., frequency and pixel domain) spatial filter. Information of both pixel domain and frequency domain is used to remove residual noise, as shown in the filtering module 14. The proposed spatial filter is adapted to the noise level function (NLF).

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing system 101, or accessible or connectable thereto. Any application or module herein described may be implemented using computer readable/executable instructions or operations that may be stored or otherwise held by such computer readable media.

The proposed time-space filter is summarized in FIG. 3. An overview of the computations executed by the computing system is presented in Algorithm 1 below.

Algorithm 1: Mixed block-pixel based noise filter

| | |
|---|---|
| i) | Estimate and compensate motion vectors in |
| | 2R (preceding, and subsequent) frames { [symbol] ₜ₊ₘ}. |
| ii) | Compute the motion error probability of each non- |
| | overlapped blocks of L × L using (3). |
| iii) | Find the averaging weights for each pixel via (11). |
| iv) | Average the motion-compensated frames using (2). |
| v) | Restore the destructed structures |
| | due to motion blur via (18) and (19). |
| vi) | Filter spatially residual noise using pixel-level |
| | noise variance σ₈² computed in (20). |

It will be appreciated that in an example aspect of the systems and methods, there are two types of “blurring” of image/video content. The first blurring of image content occurs after temporal filtering and this is referred to as motion blur; another blurring occurs after spatial filter and this is referred to as spatial or smoothing blur.

3.2 Time-Domain Filtering

3.2.1 Motion Compensated Averaging

In one aspect of the invention, the objective is to estimate the original frame Gₜ from a noise-contaminated frame Fₜ at time t utilizing the temporal information. In the proposed time-space video filtering system as illustrated for example in FIG. 3, R is the assumed radius of temporal filtering window and [symbol] ₜ₊ₘ is the motion compensated Fₜ₊ₘ. The first stage of the temporal averaging filter is defined as.

$${G}_{i} = \frac{{\sum }_{m = - R}^{R} {ω}_{m} {\vec{F}}_{t + m}}{{\sum }_{m = - R}^{R} {ω}_{m}} ; \qquad ( 2 )$$

where ωₘ is the averaging weights of each pixel with [symbol] ₜ=Fₜ and ω₀=1. To estimate ωₘ, the method uses both pixel and block levels for better error detection.

3.2.2 Block-Level Error Detection

The method uses two criteria to estimate the temporal error in block level; 1) mean of error compared to σ_{b} and 2) mean of squared error compared to σₚ. The computing system finds the reliability of each criterion (e.g. Pₘₛₑ and Pₘₑ for each block). In most of MSE-based white Gaussian temporal filters, two separate estimators are considered: one for signal and one for average of the signal. This technique is not reliable for signal-dependent noise, where mean of signal can be accurately estimated, while, due to faulty detection of error, image structure is destroyed. In the proposed method both criteria are used as in,

P_{b}=Pₘₑ*Pₘₛₑ (3)

where 0≦Pₘₑ≦1 and 0≦Pₘₛₑ≦1 are the reliability criteria to detect the error of block mean and block pixels which are used to compute ωₘ. Pₘₑ=1 implies the mean of reference block Bᵣ and motion-compensated block B_{c} are relatively close compared to block-level noise Θ_{b}(μᵣ). Pₘₛₑ=1 indicates the average error of all pixels are relatively small compared to pixel-level noise Θₚ(μᵣ). To compute Pₘₑ, first the absolute mean error δₘₑ is determined compared to expected standard deviation of temporal noise in a block,

δₘₑ=max(|μᵣ−μ_{c}|−\sqrt{2Θ_{b}(μᵣ)},0) (4)

where, μᵣ and μ_{c} are the average of a reference block and corresponding motion-compensated one. Then, the method includes determining Pₘₑ using the following likelihood function derived from normal distribution,

$${P}_{me} = exp ( - \frac{{δ}_{me}^{2}}{4 {Θ}_{b} ( {μ}_{r} )} ) \qquad ( 5 )$$

Pₘₑ defines the likelihood of block-level temporal difference to expected block-level noise variance Θ_{b}(μᵣ). The method further includes evaluating pixel-level error inside the block. Pₘₑ by itself cannot detect the error. There are cases, for example, in which the temporal error contains only HF structures, where mean of the error is very small (e.g. Pₘₑ=1). To detect the error, the method uses another criterion, Pₘₛₑ, to assess the block-level HF error. The purpose of using Pₘₛₑ is to examine cases where pixel level error is high for most of pixels in the block, which hints at motion estimation failure. However, in an example embodiment, the method does not detect motion estimation failure in cases that only few pixels are erroneous. In order to reduce to effect of high error value of few pixels on the whole block, the method limits the pixel to maximum possible temporal difference δₚ^{max}, and we compute the squared temporal difference δₘₛₑ² as the mean of limited squared difference as in,

$${δ}_{mse}^{2} = \frac{Σ [ {min ( \vert {B}_{r} - \vec{{B}_{c}} \vert , {δ}_{p}^{max} ]}^{2}}{{L}^{2}} . \qquad ( 6 )$$

Here, Bᵣ and [symbol] represent all pixels inside the reference and the corresponding motion-compensated block. In this method, the definition δₚ^{max}=(3\sqrt{2Θₚ(μᵣ)}) is used, which follows the 3σ rule. Now, the Pₘₛₑ is defined as in,

$${P}_{mse} = exp ( - {[ \frac{max ( {δ}_{mse} - {\hat{σ}}_{p} , 0 )}{{\hat{σ}}_{p}} ]}^{2} ) \qquad ( 7 )$$

where, \hat{σ}_{P}² is the average of pixel-level noise for a particular block. δₘₛₑ² is the average of pixel squared temporal difference of a block and therefore, noise value also should be the average noise of all pixels. For example,

\hat{σ}ₚ²=2Θ_{b}(μᵣ) (8)

μᵣ is the average intensity of a block. Since σ_{P}² is related to the temporal difference δₘₛₑ², (e.g. subtraction of two random variables), then the power of noise Θₚ(μᵣ) is multiplied by 2.

In the processing of the first temporal frame, (e.g. [symbol] _{t±1}), the relationship \hat{σ}_{P}²=2Θₚ(μᵣ) is considered. However, it is later proposed that an in-loop updating procedure of \hat{σ}_{P}² is used to decrease the chance of motion blur.

3.2.3 Pixel-Level Error Detection

To efficiently extract the neighborhood dependency of pixels, the method uses a low-pass spatial filter applied on the absolute of difference frames (reference and motion-compensated) to compute the pixel-level error as in,

δₚ=hₚ*|Fₜ− [symbol] ₊ₘ| (9)

where * is the convolution operator and hₚ is a 3×3 moving average filter (e.g. Gaussian kernel with a high standard deviation).

3.2.4 Calculation of Weights

Although pixel-level error detection is advantageous to represent high resolution error, few pixels cannot desirably extract errors of the motion or noise estimation. The method includes adjusting the pixel-level error by spreading the block-level error P_{b}=Pₘₑ·Pₘₛₑ to pixel-level error as in,

$${e}_{p} = \frac{{δ}_{p}}{\sqrt{{P}_{b}}} . \qquad ( 10 )$$

The computing system then computes the temporal averaging weights according to:

$${w}_{m} = exp [ - {( \frac{{e}_{p}}{\sqrt[2]{{Θ}_{p} ( {F}_{t} )}} - 1 )}^{2} ] \qquad ( 11 )$$

where Θ(Fₜ) represents the noise variance at each pixel of Fₜ.

3.2.5 Detection of Noise Overestimation

Video noise filters often assume that noise has been accurately pre-estimated. Due to difficulty of differentiation between noise and image structure, noise overestimation is possible. However, in the proposed system and method, the computing system utilizes block-level analysis to detect local overestimation. Utilizing temporal data of many pixels, (e.g. L×L) gives estimation about the local noise level. The local temporal data is used not only to estimate the averaging weights wₘ in (5) but also to detect noise overestimation in (12). This is very useful to address motion blur. Due to high coherence between reference frame Fₜ and motion-compensated [symbol] _{t±1}, there is a good chance to have a temporal difference Fₜ− [symbol] _{t±1} containing only noise due to accuracy of MVs. Thus, the computing system can adjust the noise level using the block-level analysis, during the processing of [symbol] _{t±1} and use this updated local noise in processing of [symbol] _{t±m} when |m|>1.

Mostly the motion blur artifacts are introduced when m>1 since the motion is more complex. Therefore, in case of noise overestimation, motion blur is probable but using this technique, artifacts can significantly decrease.

The computing system detects overestimated noise using local temporal data as follows. In (6), the computing system determines the average power of temporal difference of (L×L) pixels which represents the power of temporal noise if the motion is accurately estimated. This means, if δₘₛₑ² is less than the expected \hat{δ}_{P}², the computing system concludes that for that particular block, the noise is overestimated. If the computing system detects this, 2Θₚ(μᵣ) is not reliable anymore since it is overestimated. For that particular block, thus, the computing system updates (or modifies) \hat{σ}_{P}² in (8) as in,

\hat{σ}ₚ²=min(\hat{σ}ₚ²,δₘₛₑ²) (12)

The computing device stores the modified \hat{σ}_{P}² in the error bank to be used in processing of next motion-compensated frame.

3.3 Motion Estimation and Compensation

3.3.1 Block-Matching Motion Estimation

A fast multi-resolution block matching approach is used to perform motion estimation. In this approach, motion vectors are estimated in each level of resolution and the results of previous level are used to set the initial search point. The computing system considers the sum of absolute difference (SAD) as the cost function in,

SAD_{t,t+m}(x,y,vₓ,v_{y})=Σ_{x,y=0:W-1}|Fₜ(x,y)− [symbol] ₊ₘ(x+vₓ,y+v_{y})| (13)

where x and y are the column and row position of a pixel, vₓ and v_{y} is the motion vector and L is the size of the block.

The computing system uses an anti-aliasing low-pass filter hₗ to compute [symbol] ₜ=hₗ*Fₜ and therefore downscaling in order to perform multiresolution motion estimation. Multi-resolution representation of the frame is defined as in,

Fₜ¹(x,y)= [symbol] ₜ(2x,2y)

Fₜ^{j+1}(x,y)= [symbol] ₜ^{j}(2x,2y) (14)

where x and y are the pixel location. The computing system, according to an example embodiment, uses up to a maximum of 10 levels of resolution for the design depending on the finest resolution (resolution of Fₜ). Other maximum levels of resolution may be used according to other example embodiments. For example, the computing system starts from Fₜ and continues the downscaling process (e.g. Equation (14)), until it reaches a certain resolution greater than 64×64.

For all levels, the method uses a three step search (3SS) [Reference 11]. In the final step, the computing system checks the validity of estimated vector by comparing the SAD of estimated MV and the homography of MVs created from reliable MVs.

3.3.2 Homography and Faulty MV Removal

Block-matching motion estimation methods have the tendency to fall into local minima. This affects the performance of motion estimation especially when the motion is not complex (e.g., translational motion). To solve this problem, the computing system detects faulty MVs based on three steps: 1) detection of reliable MVs; 2) homography that is expansion of these reliable MVs to the whole frame; and 3) detection of the faulty homography-based MVs.

At first step, the computing system determines the reliable MVs. To do so, the computing system uses three criteria; 1) gain 2) power of error and 3) repetition. An MV is herein defined as being reliable when it meets all three criteria. The motion estimation gain gser is herein defined as:

$${g}_{ser} = \frac{{L}^{2} VAR ( {B}_{r} )}{{Σ [ {B}_{r} - {\vec{B}}_{c} ]}^{2}} \qquad ( 15 )$$

where VAR(Bᵣ) is the variance of reference block Bᵣ, L is size of block, and [symbol] _{c} is the corresponding motion-compensated block. For a block that contains only Gaussian noise, gₛₑᵣ≦0.5. A threshold thₛₑᵣ=3 is defined to include only MVs that gₛₑᵣ≧thₛₑᵣ and remove the rest. The second criterion is the power of error Σ[Bᵣ− [symbol] _{c}]². A threshold thₚₑᵣ is also defined and the computing system removes the MVs that the power of error is higher than this threshold. To determine thₚₑᵣ, the computing system analyses those blocks which succeeded to meet the gain condition and it identifies the one block with minimum power of error. Assuming the minimum power of error for all blocks that met the first criterion is δₘᵢₙ², the threshold is defined as thₚₑᵣ=4δₘᵢₙ² and the computing system removes MVs with the power of error higher than this value. The third criterion is the repetition of MVs. MVs that are not repeated are likely to be outliers. Thus, in an example embodiment, the computing system includes only MVs that are repeated at least three times and remove the rest. At this point, the computing system has identified the reliable MVs.

In the second step, the computing system creates the homography based on reliable MVs. To create the homography of MVs, the computing system diffuses reliable MVs to unreliable neighbours and this procedure is continued until all blocks are assigned with a reliable MV.

At the final step, the computing system compares the SADs from homography and initially estimated MVs (using 3SS) to find the least cost and therefore detect probable homography failure.

3.3.3 Multi-Frame Motion Estimation

Temporal filtering window includes 2R+1 frames which requires 2R motion estimation per frame. This is very time-consuming when R>>1.

To reach the speed efficiency, in an example embodiment, the computing system performs only one motion estimation per frame and computes the other MVs from that. Assuming V_{t,t+1} represents the motion vectors between two adjacent frames Fₜ and Fₜ₊₁. The computing system calculates the other MVs for subsequent frames as in.

V_{t,t+m}=Σₖ₌ₜ^{t+m-1}V_{k,k+1};1<m≦R (16)

Since we do not perform a subpixel motion estimation for V_{t,t+1}, subpixel displacement can be accumulated and create a pixel displacement on V_{t,t+m} for m>1. To compensate that, the computing system performs another motion estimation with small search radius (less than 4) using V_{t,t+m} in (16) as the initial search position.

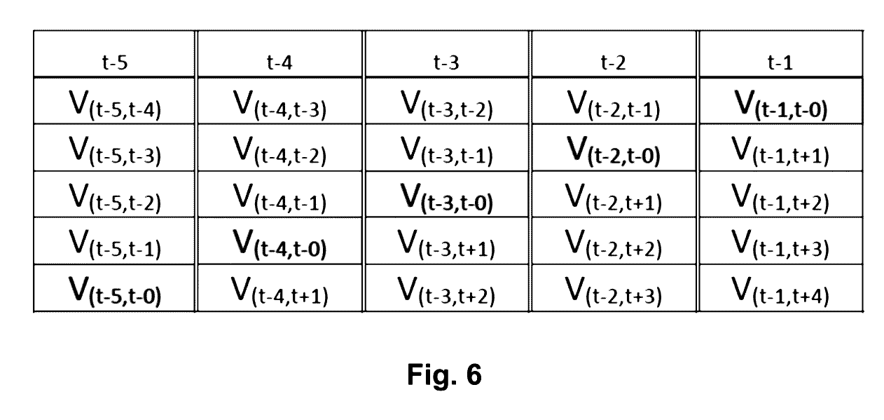

To reach the maximum speed in our design we compute the backward motion vectors (e.g. MVs between Fₜ and preceding frames Fₜ₋ₘ), the computing system stores in memory all the forward estimated MVs within the radius of R and uses them in the future time. FIG. 6 shows the stored MVs (MV bank) for R=5. At the time t forward motion estimation in the past, e.g., V_{t-m,t} with 1≦m≦R defines the motion between frame reference frame Fₜ and preceding frames Fₜ₋ₘ.

The problem is now how to convert forward MVs in the past, e.g., V_{t-m,t} to backward MVs in the time t, e.g., V_{t,t-m}.

To address this problem, the computing system performs an inverse operation to estimate V_{t,t-m} from Vt−m,t. The only challenge is that block-matching algorithms are not a one to one function meaning two MVs may point to same location. Therefore, the inverse motion estimation operation may leave some blocks without MVs assigned to them. In this case, the computing system uses valid MVs of neighbor blocks to assign a MV to them. At the end of inverse operation, the computing system creates homography and reconfirms the estimated MVs as described in the process or module for homography and faulty MV removal, as part for the motion estimation and compensation process or module.

3.3.4 Deblocking

Block-matching methods used in video denoising applications are fast and efficient. However, they introduce blocking artifacts in the output of denoised frame.

The deblocking described herein aims at reducing blocking artifacts resulting from block-matching. It can also be used to reduce coding blocking artifacts in the input frames. A blocking artifact is the effect of strong discontinuity of MVs which leads to a sharp edge between each adjacent block. In order to address this, the computing system examines if there is a MV discontinuity and if a sharp edge has been created which did not exist in the reference frame. If so, the computing system concludes that a blocking artifact has been created.

MV discontinuity can be found by looking at the MV of each adjacent block. If either vertical or horizontal motion of two adjacent blocks is different, then discontinuity occurred.

To detect the edge artifact on the boundary of a block, the computing system analyzes the HF behaviour by looking at how much the edge is powerful compared to the reference frame. The term p_{blk} is herein defined as a blocking criterion as in,

$${p}_{blk} = \frac{\vert {h}_{hp} * {\overline{{F}_{t}}}_{+ m} \vert}{\vert {h}_{hp} * {F}_{t} \vert + 1} . \qquad ( 17 )$$

where hₕₚ is 3×3 high-pass filter. A blocking artifact is herein defined for each pixel of the block-motion compensated frame F̅ₜ₊ₘ with MV discontinuity and p_{blk}≧2. Then the computing system replaces the HF edges of hₕₚ*F̅ₜ₊ₘ by smoothed HF. To compute this, among two adjacent MVs, the computing system selects the MV that leads to less value of p_{blk}. Thus, for each pixel, the computing system finds the HF with highest similarity to the reference frame.

3.4 Signal Restoration from Motion Blur

The main goal of this step is to restore the distorted structures of the image caused by temporal filtering. This undesired distortion, which is known as motion blur, occurs due to inaccuracy of both motion and noise estimation. The computing system may use perform the restoration in two steps. At the first step, the computing system restores the mean of signal in block-level resolution. At the second step, the computing system applies the pixel-level restoration. Assuming μ_{f} represents the mean of specific block in Gₜ, the computing system updates the mean of that block by modifying it to μ_{c} as in,

$${μ}_{c} = {μ}_{f} + ( {μ}_{r} - {μ}_{f} ) exp ( - \frac{10 {Θ}_{b} ( {μ}_{r} )}{{( {μ}_{r} - {μ}_{f} )}^{2}} ) \qquad ( 18 )$$

High values of block-level error lead to μ_{c} close to μᵣ. In an example embodiment, the constant 10 is considered to restore when the error is very high. In the second step, the computing system restores pixel-level LFs, since HF are very likely to be noise. Assuming after block-level restoration the filtered frame Gₜ becomes G̅ₜ, the computing system updates G̅ₜ by restoring probable blurred (destroyed) structures as in,

$${\tilde{G}}_{t} = {\overline{G}}_{t} + [ {h}_{l} * ( {F}_{t} - {\overline{G}}_{t} ) ] exp ( - \frac{{Θ}_{p} ( {P}_{t} )}{{[ {h}_{l} * ( {F}_{t} - {\overline{G}}_{t} ) ]}^{2}} ) \qquad ( 19 )$$

where, hₗ is a 3×3 moving average filter, e.g., Gaussian kernel with a high sigma value and G̅ₜ is the output of restoration. In the case of strong LF error, LF signal is restored by replacing hₗ*Fₜ by hₗ*G̅ₜ.

3.5 Spatial Filtering

It is assumed noise has been reduced temporally via (2). The computing system calculates the residual noise of each pixel of G̅ₜ as in.

$${σ}_{s}^{2} = {Θ}_{p} ( {F}_{t} ) \frac{{Σ}_{m = - R}^{R} {w}_{m}^{2}}{{( {Σ}_{m = - R}^{R} {w}_{m} )}^{2}} \qquad ( 20 )$$

where σₛ² is a map of noise for each pixel which is defined based on how much noise reduction for each pixel occurred and the amount of noise variance associated to that pixels.

According to residual power of noise σₛ², a filter can be used to remove the noise remained after temporal processing.

Pixel-domain spatial filters are more efficient than transform-domain in this situation since σₛ² is a pixel-level noise map. These filters are efficient in preserving high-contrast details such as edges. It is herein recognized however, they have difficulties preserving low-contrast repeated patterns. Transform domain methods (e.g., Wavelet shrinkage), conversely, preserve textures but introduce ringing artifacts.

The systems and methods proposed herein use a hybrid approach to benefit both. First, the computing system filters high-contrast details by averaging of the neighbor pixels. After, low-contrast textures in the residual image are constructed by short time Fourier transform (STFT) shrinkage.

The edge stopping average kernel is herein defined over a square neighborhood window Nₓ centered around every pixel x with window radius r=1:7. Assuming \tilde{G}ₜ(x) represents the intensity of pixel x in \tilde{G}ₜ, then the computing system calculates the weighted average of intensities over x and its neighborhood Ġₜ(x) as in

$${\dot{G}}_{t} ( x ) = {\tilde{G}}_{t} ( x ) + \frac{{Σ}_{y ∈ {N}_{x}} {k}_{x , y} {\tilde{G}}_{t} ( y )}{1 + {Σ}_{y ∈ {N}_{x}} {k}_{x , y}} \qquad ( 21 )$$

k_{x,y} weights are calculated based on Euclidean distance of intensity values and spatial positions as in,

$${k}_{x , y} = exp ( - \frac{{\vert x - y \vert}^{2}}{{c}_{s}} ) exp ( - \frac{{\vert {\tilde{G}}_{t} ( x ) - {\tilde{G}}_{t} ( y ) \vert}^{2}}{2 {σ}_{s}^{2}} ) \qquad ( 22 )$$

where the constants cₛ defines the correlation between center pixel and its neighborhood which is set to 25. Next, the computing system computes the residual image Z=\tilde{G}ₜ−Ġₜ and then shrinks the noisy Fourier coefficients of residual to restore the low-contrast textures.

For speed consideration, the computing system uses overlapped blocks of L×L pixels. Assuming Z_{f} is the Fourier coefficient of residual image block, the shrinkage function is defined as follows

$${\tilde{Z}}_{f} = {Z}_{f} exp ( - \frac{4 {σ}_{ft}^{2}}{{z}_{f}^{2}} ) \qquad ( 23 )$$

where σ_{ft}² is the average values of σₛ² inside the L×L block. The inverse Fourier transform is applied on the shrunk \tilde{Z}_{f} and the overlapping blocks are accumulated to reconstruct weak structures. Then the final output of the proposed filter is

\tilde{G}ₜ=Ġₜ+FT⁻¹(\tilde{Z}_{f}) (24)

where FT⁻ is the inverse Fourier transform.

3.6 Chrominance Noise Filtering

Re-computing averaging weights for chrominance channels, or using a 3D block of data using 3 channels to compute averaging weights is complex. Mostly, sensor arrays in cameras are designed to have higher signal to noise ratio in luminance channel than chrominance. Thus, temporal correlation is more reliable in luminance channel. Moreover, in most of the video codecs chrominance data is sub-sampled and not trustworthy. Therefore, computation time can be saved in temporal stage by using the same w; computed for luminance channel to perform filtering in chrominance channel. However, using the luminance channel leads to unlikely chrominance artifacts, which should be detected and removed. The same procedure of signal restoration discussed in the section 3.4 related to signal restoration for motion blur is proposed for this matter.

The computing system uses both block-level and pixel-level restoration with the corresponding noise values for chrominance channels, e.g. σ_{pU}² and σ_{bU}² for pixel and block-level noise variance of U, and σ_{pV}² and σ_{bV}² pixel and block-level noise variance of V channels. In an example embodiment in which signal-dependency for chroma channels are not considered, Θ(.)=1.

### 4. EXPERIMENTAL RESULTS

The presented example embodiment of a filtering method has been implemented and the results have been compared to state-of-the-art video denoising methods. To evaluate the performance of the proposed noise reduction, the performance is herein compared to these filters: VBM3D [Reference 4], MHMCF [Reference 17], and ST-GSM [Reference 2]. Different experiments have been conducted using synthetic and real-world noise. For the synthetic noise experiment, three noise types including AWGN, PGN (signal-dependent), and PPN (frequency and signal-dependent), has been generated. For the real-world experiment, simulation results have been tested for very challenging sequences. Simulation results are given for the gray-level format of test video sequences. However, on other tests using color sequences, the methods and systems described herein also outperforms related work.

The proposed method has two parameters: block size L and temporal window R. The parameter L is set to L=16 in the simulations.

Temporal window R means that the computing system processed R previously and R for subsequent frames. In the example experiment, the value R=5 is used since it gives best quality-speed compromise; however, 0≦R≦5 can be selected depending on the factors: application, processing pipeline delay, and hardware limits.

4.1 Speed of Implementation

In the experiment, the proposed method was implemented on both CPU and GPU platforms using C++ and OpenCL programming languages. Using Intel i7 3.07 GHz CPU and Nvidia GTX 970 GPU, the method and system processed VGA videos (640×480) in real-time (e.g. 30 frame per second).

To relate the computational complexity of the proposed method to state-of-the-arts methods, the experiment ran VBM3D (implemented in Matlab mex, e.g., compiled C/C++) and the proposed method (implemented in C++/OpenCL) on bg_left video of resolution 1920×1080. The proposed method took 172 miliseconds per frame while VBM3D required 8635 miliseconds per frame.

4.2 Motion Estimation

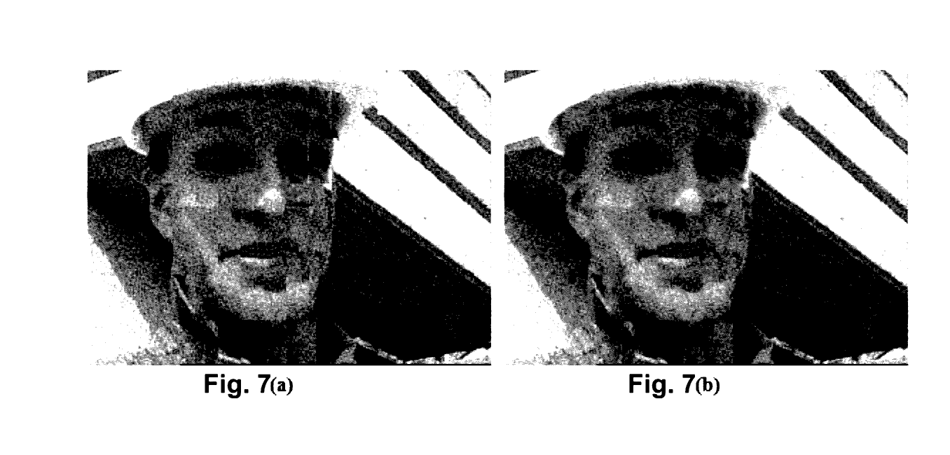

FIG. 7 shows the effect of deblocking on a sample motion compensated frame. Especially visible is deblocking in the eye area. In particular, FIG. 7(a) shows block-matching before deblocking, and FIG. 7(b) shows block-matching after deblocking. Sharp edges created by block-matching in FIG. 7(a) are removed in FIG. 7(b).

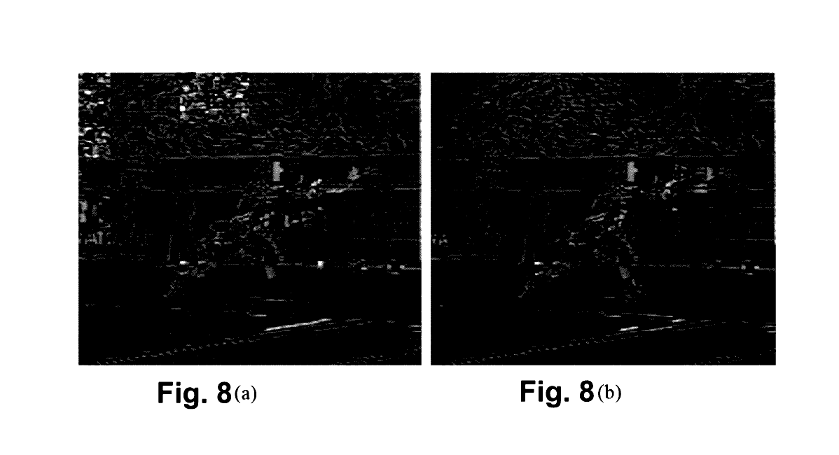

FIG. 8 shows the how homography creation affects the performance of motion estimation. In particular, FIG. 8(a) shows an example image before homography creation, and FIG. 8(b) shows an example image after homography creation. The effects of homography creation on the performance of motion estimation are shown by analysing the difference between the reference frame and the motion-compensated frame. As can be seen, e.g., in the upper left part, the error between reference and motion-compensated frames using homography based MVs is significantly less than without.

4.3 Effect of Temporal Radius and Spatial Filter

As the computing system increases the temporal radius R, the computing system is able to have access to more temporal data and the denoising quality increases.

In case of lack of information of temporal data, for example, due to faulty MVs, the spatial filter should compensate this. This is important since it is desirable to have consistent denoising results in cases that MVs are partially correct.

Here is an example: assume R=5 and the estimated MVs for half of the frame are correct and for the other frame half these MVS are partially correct such that only temporal data within the radius of R=1 is correct. In this case, the output of the temporal filter will have half the frame well denoised and the other half partially denoised. Theoretically, the PSNR difference of these two parts of frame is

$$10 {log}_{10} ( \frac{11}{3} ) = 5.6$$

dB which is very high. In these cases, the role of spatial filter is very important to denoise more when the residual noise is higher.

To evaluate the effect of spatial filter, in removal of the residual noise after temporal filtering, the experiment includes testing two videos with different radii where AWGN of PSNR=25.

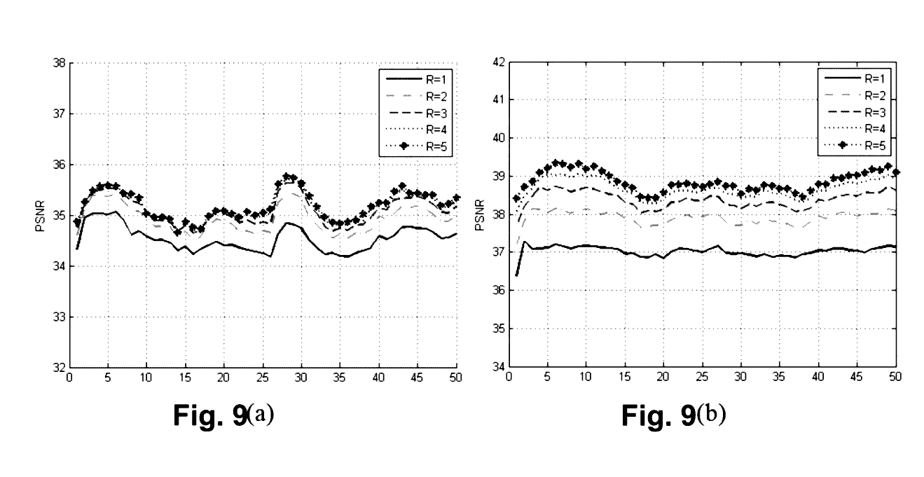

FIG. 9 shows the effect of increasing the R on the denoising quality of the proposed filter. Two videos with small motion (Akiyo) and complex motion (Foreman) have been tested. In particular, FIG. 9(a) shows the effects using video with complex motion (Foreman), and FIG. 9(b) show video with small motion (Akiyo). In theory, by using only temporal data the PSNR difference between R=1 and R=2 should be

$$10 {log}_{10} ( \frac{5}{3} ) = 2.2 dB .$$

However, using the temporal filter and the spatial filter, the difference becomes less than 1 dB since the spatial filter compensates the lack of temporal information.

4.4 Synthetic AWGN

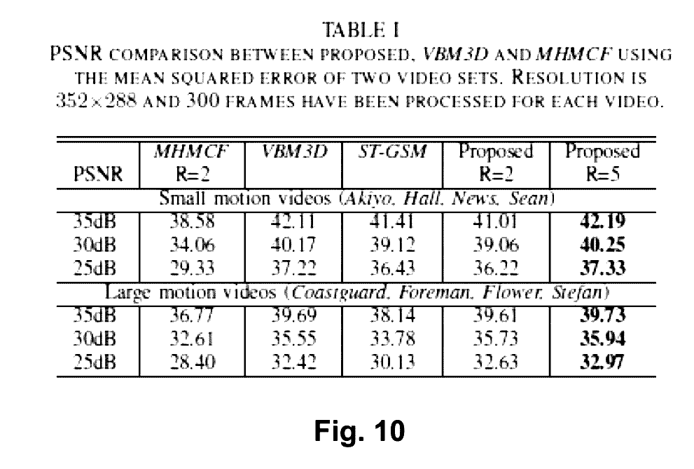

To evaluate the performance under the AWGN, two video groups with large motion and small motion have been selected. AWGN has been added to the gray-scale original frames with three levels of peak signal-to-noise ratio (PSNR), 35 dB, 30 dB and 25 dB. The temporal filters MHMCF [Reference 17] and VBM3D [Reference 4] are selected for this experiment. Table I, shown in FIG. 10, demonstrates the averaged PSNR of filtered frames in both video groups. As can be seen, it achieves competitive results in comparison with other methods.

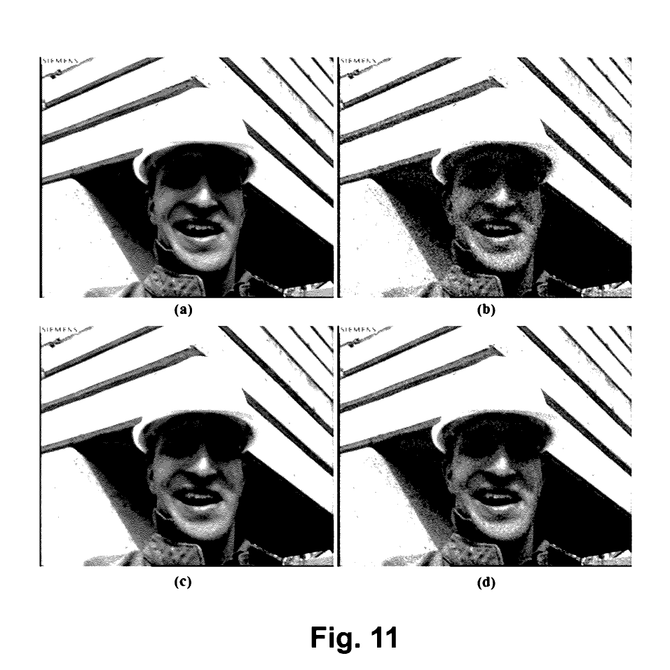

FIG. 11 evaluates the visual results of proposed method compared to MHMCF with R=2 for both methods. FIG. 11(a) show the original frame, FIG. 11(b) shows the noisy frame PSNR=25 dB, FIG. 11(c) shows noise reduced by the proposed method, and FIG. 11(d) shows noise reduced by MHMCF. Noise is better removed using the proposed approach and less noise is visible, e.g., in the face.

4.5 Synthetic Signal-Dependent Noise

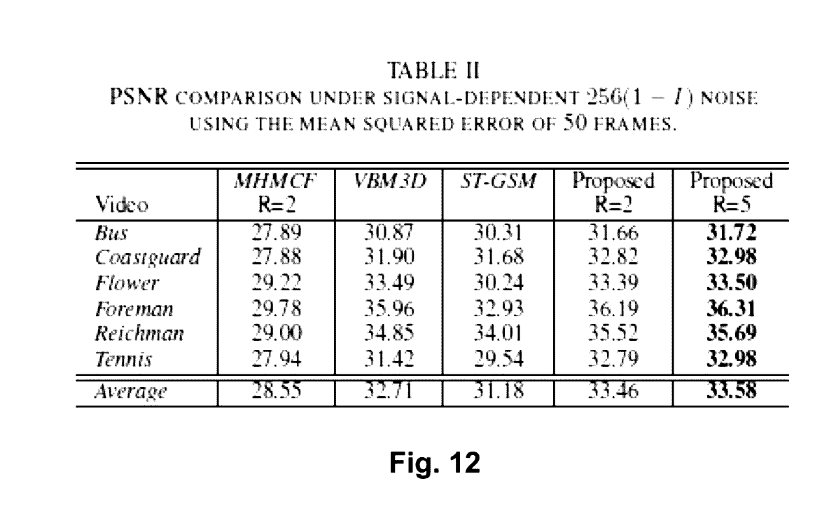

In the experiment, synthetic signal-dependent Gaussian noise was added to seven video sequences using a linear NLF Θ(I)=(1−I) where I represents the normalized intensity level in the range of [0 1]. The proposed filter and three other video filters, MHMCF [Reference 17], ST-GSM [Reference 2] and VBM3D [Reference 4], have been applied on the noisy contents using σₚ²=256, σ_{b}²=1, and Θ(I)=(1−I) with Table II (see FIG. 12) showing the proposed filter is more reliable under signal-dependent noise.

4.6 Synthetic Processed Signal-Dependent Noise

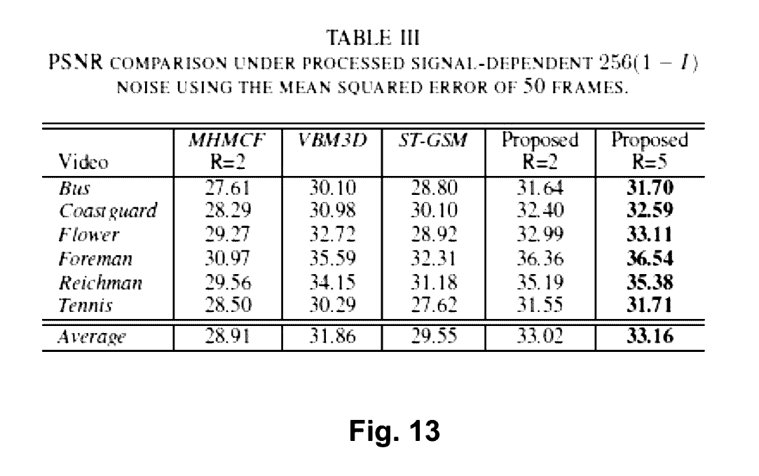

Another experiment includes using the classical anisotropic diffusion filter [Reference 36] to process signal-dependent Gaussian noise and suppress high frequency components of the noise. This filter is applied on the sequences created from previous experiment, e.g. σₚ²=256, σ_{b}²=1, and Θ(I)=(1−I). The experiment includes considering a single iteration anisotropic diffusion filter with Δt=0.2. Table III (see FIG. 13) shows the method proposed herein is successful at achieving better results in comparison with other methods.

4.7 Real World (Non-Synthetic) Noise

In another experiment, the proposed filter was tested on real-world noisy video sequences. To objectively evaluate denoising without a reference frame, the no-reference quality index MetricQ [Reference 37] was used.

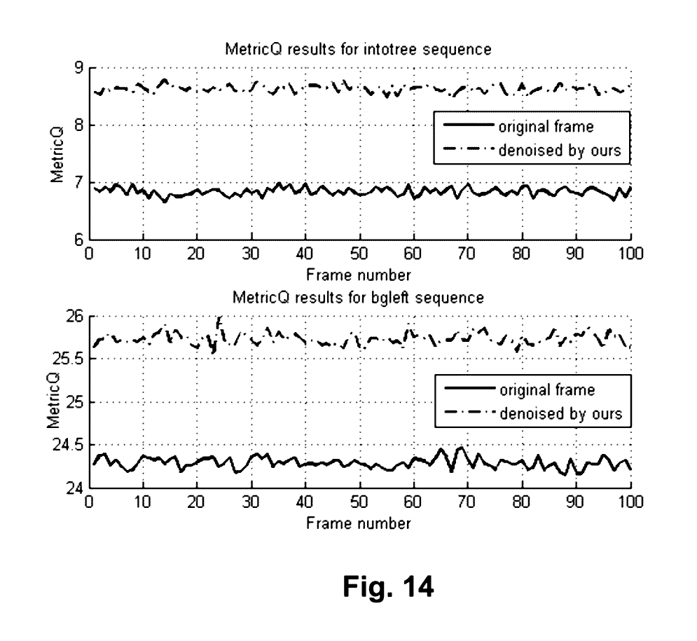

FIG. 14 compares MetricQ of denoised output and noisy input frames of the video intotree and bgleft with a higher value indicating better quality. As can be seen, the proposed method increases the quality of the video. Here, noise variance and NLF were automatically estimated using the method described in Applicant's U.S. Patent Application No. 61/993,469 filed on May 15, 2014, and incorporated herein by reference.

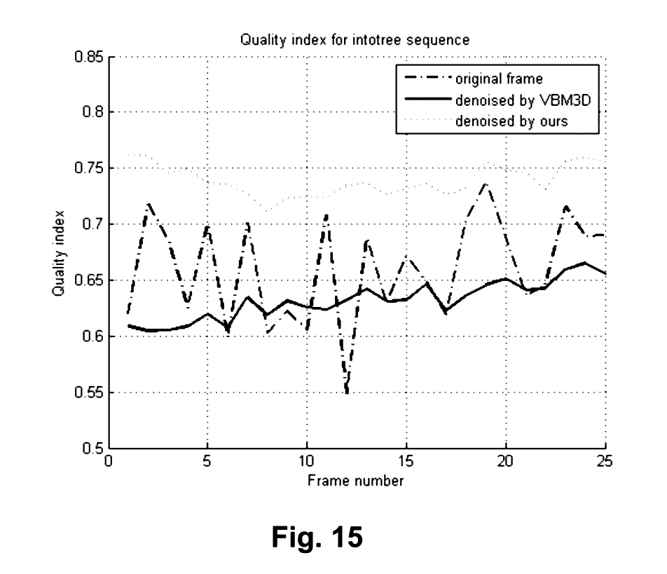

FIG. 15 objectively compares the quality index using [Reference 38] for the first 25 frames of intotree sequence denoised by VBM3D and the proposed method, which shows higher quality index values for the proposed method. Here too, the noise is automatically estimated using the method described in Applicant's U.S. Patent Application No. 61/993,469.

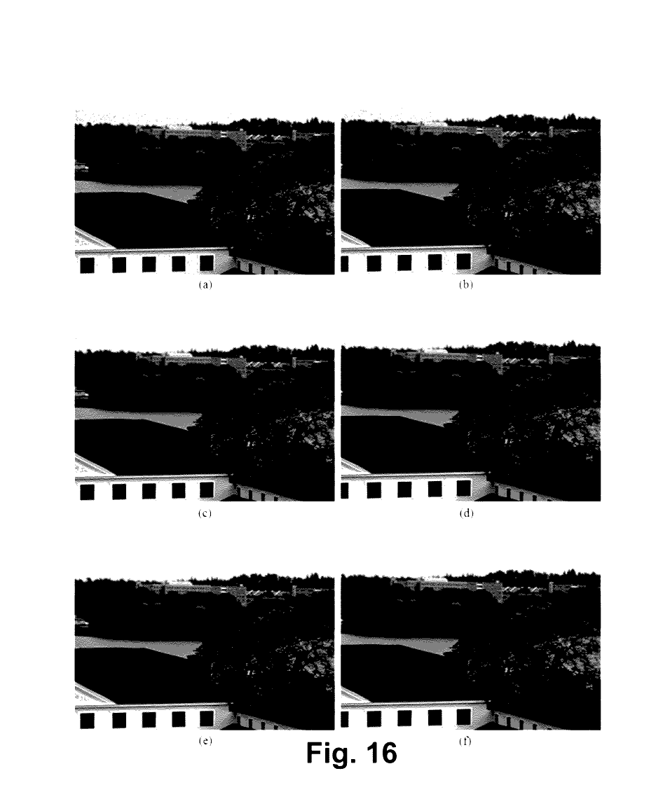

Subjectively, FIG. 16 shows visual results of proposed versus VBM3D methods using the automated noise estimator, for both methods, in Applicant's U.S. patent application No. 61/993,469.

To confirm these visual results, a quality index (QI) that was proposed in [Reference 38] was used to compare the results objectively. FIGS. 16 (a) and (b) show part of original frames 10 and 20 with QI of 0.61 and 0.69. FIGS. 16 (c) and (d) show part of frames 10 and 20 denoised by VBM3D [Reference 4] with QI of 0.62 and 0.65. FIGS. 16 (e) and (f) show part of frames 10 and 20 denoised by proposed with QI of 0.72 and 0.74. Motion blur on the roof and trees is visible in (c) and (d) and noise is left in the sky. Noise is better removed with less motion blur in (e) and (f).

Furthermore, the filter of the proposed system and method was applied on the real noisy sequence (intotree, from SVT HD Test Set) using both fixed (Θ(I)=1) and linear (Θ(I)=I) NLF. This means the noise was manually estimated and assumed a linear Θ(I)=I.

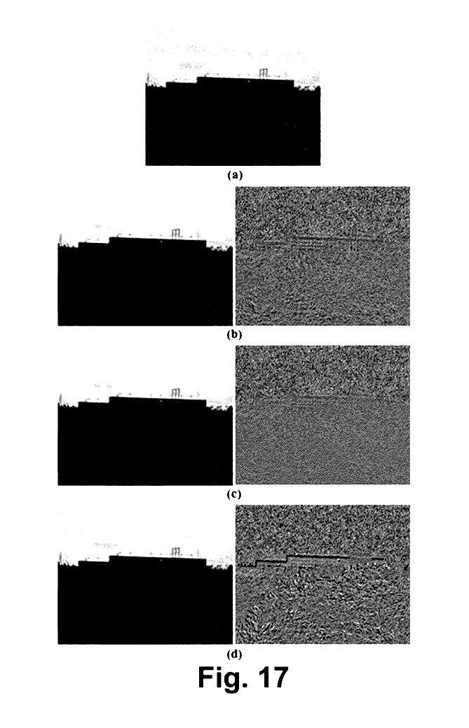

FIG. 17 compares the denoised contents and corresponding differences with the original for the proposed and MHMCF filters. In particular, FIG. 17(a) is the original image. FIG. 17(b) is filtered using the proposed method with σₚ²=36 and Θ(I)=1. FIG. 17(c) is filtered using the proposed method with σₚ²=42 and Θ(I)=1. FIG. 17(d) is filtered using MHMCF with σₚ²=36. With the proposed filter, not only is the motion blur significantly less, but noise removal is also more apparent.

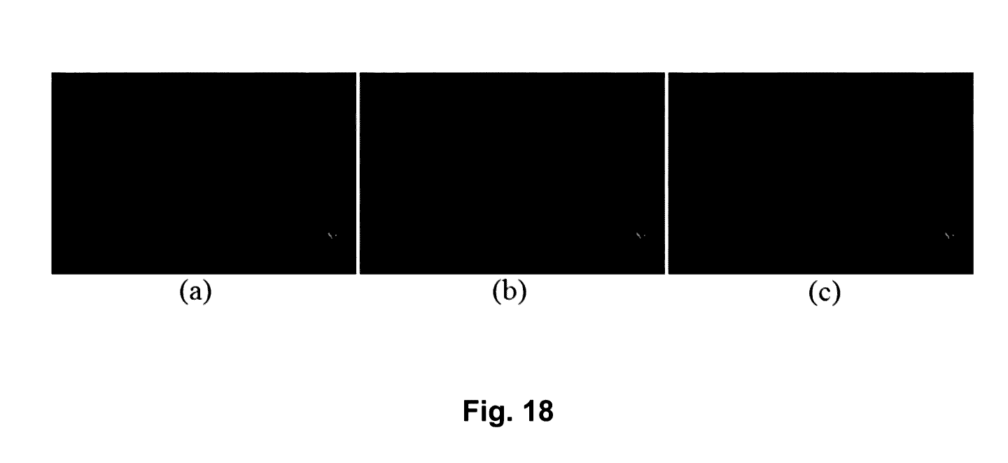

FIG. 18 also shows visual result of proposed versus VBM3D [Reference 4]. FIG. 18(a) shows the original image. FIG. 18(b) shows VBM3D [Reference 4] (σₚ²=36). FIG. 18(c) shows the proposed an image processed using the proposed filter with the parameter (σₚ²=36). As can be seen, image details using VBM3D are blurred, but well preserved using the proposed filter.

### 5. CONCLUSION

It will be appreciated that a time-space video denoising method is described herein, which is fast, yet yields competitive results compared to the state-of-the-art methods. Detecting motion and noise estimation errors effectively, it introduces less blocking and blurring effects compared to relevant methods. The proposed method is adapted to the input noise level function in signal-dependent noise and to the processed noise using both coarse and fine resolution in frequency-dependent noise. By preserving the image structure, the proposed method is a practical choice for noise suppression in real-world situations where the noise is signal-dependent or processed signal-dependent. Benefiting from motion estimation, it can also be a solution for a denoiser codec combination to decrease the bit rate in noisy conditions.

### 6. References

The details of the references mentioned above, and shown in square brackets, are listed below. It is appreciated that these references are hereby incorporated by reference.
[Reference 1] S. M. M. Rahman, M. O. Ahmad, and M. N. S. Swamy, “Video denoising based on inter-frame statistical modeling of wavelet coefficients,” Circuits and Systems for Video Technology, IEEE Transactions on, vol. 17, no. 2, pp. 187-198, February 2007.
[Reference 2] G. Varghese and Zhou Wang, “Video denoising based on a spatiotemporal Gaussian scale mixture model,” Circuits and Systems for Video Technology, IEEE Transactions on, vol. 20, no. 7, pp. 1032-1040, July 2010.
[Reference 3] M. Protter and M. Elad, “Image sequence denoising via sparse and redundant representations,” Image Processing, IEEE Transactions on, vol. 18, no. 1, pp. 27-35, January 2009.
[Reference 4] Kostadin Dabov, Alessandro Foi, and Karen Egiazarian, “Video denoising by sparse 3d transform-domain collaborative filtering,” in Proc. 15^{th} European Signal Processing Conference, 2007, vol. 1, p. 7.
[Reference 5] V. Ziokolica, A. Pizurica, and W. Philips, “Wavelet-domain video denoising based on reliability measures,” Circuits and Systems for Video Technology, IEEE Transactions on, vol. 16, no. 8, pp. 993-1007, August 2006.
[Reference 6] Fu Jin, Paul Fieguth, and Lowell Winger, “Wavelet video denoising with regularized multiresolution motion estimation,” EURASIP Journal on Advances in Signal Processing, vol. 2006, 2006.
[Reference 7] M. Maggioni, G. Boracchi, A. Foi, and K. Egiazarian, “Video denoising, deblocking, and enhancement through separable 4-d nonlocal spatiotemporal transforms,” Image Processing, IEEE Transactions on, vol. 21, no. 9, pp. 3952-3966, September 2012.
[Reference 8] F. Luisier, T. Blu, and M. Unser, “Sure-let for orthonormal wavelet domain video denoising,” Circuits and Systems for Video Technology, IEEE Transactions on, vol. 20, no. 6, pp. 913-919, June 2010.
[Reference 9] E. J. Balster, Y. F. Zheng, and R. L. Ewing, “Combined spatial and temporal domain wavelet shrinkage algorithm for video denoising,” Circuits and Systems for Video Technology, IEEE Transactions on, vol. 16, no. 2, pp. 220-230, February 2006.
[Reference 10] Andr'es Bruhn, Joachim Weickert, and Christoph Schnorr, “Lucas/kanade meets horn/schunck: Combining local and global optic flow methods,” International Journal of Computer Vision, vol. 61, no. 3, pp. 211-231, 2005.
[Reference 11] Renxiang Li, Bing Zeng, and M.-L. Liou, “A new three-step search algorithm for block motion estimation,” Circuits and Systems for Video Technology, IEEE Transactions on, vol. 4, no. 4, pp. 438-442, August 1994.
[Reference 12] Lai-Man Po and Wing-Chung Ma, “A novel four-step search algorithm for fast block motion estimation,” Circuits and Systems for Video Technology, IEEE Transactions on, vol. 6, no. 3, pp. 313-317, June 1996.
[Reference 13] G. Gupta and C. Chakrabarti, “Architectures for hierarchical and other block matching algorithms,” Circuits and Systems for Video Technology, IEEE Transactions on, vol. 5, no. 6, pp. 477-489, December 1995.
[Reference 14] Kwon Moon Nam, Joon-Seek Kim, Rae-Hong Park, and Young Serk Shim, “A fast hierarchical motion vector estimation algorithm using mean pyramid,” Circuits and Systems for Video Technology, IEEE Transactions on, vol. 5, no. 4, pp. 344-351, August 1995.
[Reference 15] J. C.-H. Ju, Yen-Kuang Chen, and S-Y Kung, “A fast rate-optimized motion estimation algorithm for low-bit-rate video coding,” Circuits and Systems for Video Technology, IEEE Transactions on, vol. 9, no. 7, pp. 994-1002, October 1999.
[Reference 16] Xudong Song, Tihao Chiang, X. Lee, and Ya-Qin Zhang, “New fast binary pyramid motion estimation for mpeg2 and hdtv encoding.” Circuits and Systems for Video Technology, IEEE Transactions on, vol. 10, no. 7, pp. 1015-1028, October 2000.
[Reference 17] Liwei Guo, O. C. Au, Mengyao Ma, and Zhiqin Liang, “Temporal video denoising based on multihypothesis motion compensation,” Circuits and Systems for Video Technology, IEEE Transactions on, vol. 17, no. 10, pp. 1423-1429, October 2007.
[Reference 18] Ziwei Liu, Lu Yuan, Xiaoou Tang, Matt Uyttendaele, and Jian Sun, “Fast burst images denoising,” ACM Transactions on Graphics (TOG), vol. 33, no. 6, pp. 232, 2014.
[Reference 19] M. Rakhshanfar and M. A. Amer, “Motion blur resistant method for temporal video denoising,” in Image Processing (ICIP), 2014 IEEE International Conference on, October 2014, pp. 2694-2698.
[Reference 20] Shigong Yu, M. O. Ahmad, and M. N. S. Swamy, “Video denoising using motion compensated 3-d wavelet transform with integrated recursive temporal filtering,” Circuits and Systems for Video Technology, IEEE Transactions on, vol. 20, no. 6, pp. 780-791, June 2010.
[Reference 21] Jingjing Dai, O. C. Au, Chao Pang, and Feng Zou, “Color video denoising based on combined interframe and intercolor prediction,” Circuits and Systems for Video Technology, IEEE Transactions on, vol. 23, no. 1, pp. 128-141, January 2013.
[Reference 22] Dongni Zhang, Jong-Woo Han, Jun hyung Kim, and Sung-Jea Ko, “A gradient saliency based spatio-temporal video noise reduction method for digital tv,” italicize Consumer Electronics. IEEE Transactions on, vol. 57, no. 3, pp. 1288-1294, August 2011.
[Reference 23] Byung Cheol Song and Kang-Wook Chun, “Motion-compensated temporal prefiltering for noise reduction in a video encoder,” in Image Processing, 2004, ICIP '04, 2004 International Conference on, October 2004, vol. 2, pp. 1221-1224 Vol. 2.
[Reference 24] Li Yan and Qiao Yanfeng, “An adaptive temporal filter based on motion compensation for video noise reduction,” in Communication Technology, 2006. ICCT '06. International Conference on, November 2006, pp. 1-4.
[Reference 25] Shengqi Yang and Tiehan Lu, “A practical design flow of noise reduction algorithm for video post processing,” Consumer Electronics, IEEE Transactions on, vol. 53, no. 3, pp. 995-1002, August 2007.
[Reference 26] T. Portz, Li Zhang, and Hongrui Jiang, “High-quality video denoising for motion-based exposure control,” in Computer Vision Workshops (ICCV Workshops), 2011 IEEE International Conference on, November 2011, pp. 9-16.
[Reference 27] H. Tan, F. Tian, Y. Qiu, S. Wang, and J. Zhang, “Multihypothesis recursive video denoising based on separation of motion state,” Image Processing, IET, vol. 4, no. 4, pp. 261-268, August 2010.
[Reference 28] Ce Liu and William T Freeman, “A high-quality video denoising algorithm based on reliable motion estimation,” in Computer Vision-ECCV 2010, pp. 706-719. Springer, 2010.
[Reference 29] Jingjing Dai, O. C. Au, Wen Yang, Chao Pang. Feng Zou, and Xing Wen, “Color video denoising based on adaptive color space conversion,” in Circuits and Systems (ISCAS), Proceedings of 2010 IEEE International Symposium on, May 2010, pp. 2992-2995.
[Reference 30] K. Dabov. A. Foi, V. Katkovnik, and K. Egiazarian, “Image denoising by sparse 3-d transform-domain collaborative filtering.” Image Processing, IEEE Transactions on, vol. 16, no. 8, pp. 2080-2095, August 2007.
[Reference 31] S R Reeja and N P Kavya, “Real time video denoising,” in Engineering Education: Innovative Practices and Future Trends (AICERA), 2012 IEEE International Conference on. IEEE, 2012, pp. 1-5.
[Reference 32] Thomas Brox, Andr'es Bruhn, Nils Papenberg, and Joachim Weickert, “High accuracy optical flow estimation based on a theory for warping,” in Computer Vision-ECCV 2004, pp. 25-36. Springer, 2004.
[Reference 33] Shan Zhu and Kai-Kuang Ma, “A new diamond search algorithm for fast block-matching motion estimation,” Image Processing, IEEE Transactions on, vol. 9, no. 2, pp. 287-290, February 2000.
[Reference 34] Prabhudev Irappa Hosur and Kai-Kuang Ma, “Motion vector field adaptive fast motion estimation,” in Second International Conference on Information, Communications and Signal Processing (ICICS99), 1999, pp. 7-10.
[Reference 35] Hoi-Ming Wong, O. C. Au, Chi-Wang Ho, and Shu-Kei Yip, “Enhanced predictive motion vector field adaptive search technique (e-pmvfast)-based on future my prediction,” in Multimedia and Expo, 2005. ICME 2005. IEEE International Conference on, July 2005, pp. 4 pp.
[Reference 36] Pietro Perona and Jitendra Malik, “Scale-space and edge detection using anisotropic ditTusion,” Pattern Analysis and Machine Intelligence, IEEE Transactions on, vol. 12, no. 7, pp. 629-639, 1990.
[Reference 37] X. Zhu and P. Milanfar, “Automatic parameter selection for denoising algorithms using a no-reference measure of image content.” Image Processing, IEEE Trans. on, vol. 19, no. 12, pp. 3116-3132, 2010.
[Reference 38] M. Rakhshanfar and M. A. Amer, “Systems and Methods to Assess Image Quality Based on the Entropy of Image Structure” in Provisional U.S. Patent Application No. 62/158,748, filed May 8, 2015.

It will be appreciated that the features of the systems and methods for reducing noise based on motion-vector errors and image blurs are described herein with respect to example embodiments. However, these features may be combined with different features and different embodiments of these systems and methods, although these combinations are not explicitly stated.

While the basic principles of these inventions have been described and illustrated herein it will be appreciated by those skilled in the art that variations in the disclosed arrangements, both as to their features and details and the organization of such features and details, may be made without departing from the spirit and scope thereof. Accordingly, the embodiments described and illustrated should be considered only as illustrative of the principles of the inventions, and not construed in a limiting sense.

1. A method performed by a computing system for filtering noise from video data, the method comprising:
applying time-domain filtering on a current frame of a video using one or more motion-compensated previous frames and one or more motion-compensated subsequent frames;
restoring blurred content in the current frame; and
applying spatial filtering to the current frame to remove residual noise resulting from the time-domain filtering.

2. The method of claim 1 further comprising estimating and compensating one or motion vectors obtained from one or more previous frames and one or more subsequent frames, to generate one or more motion-compensated previous frames and one or more motion-compensated subsequent frames.

3. The method of claim 2 further comprising: identifying one or more reliable motion vectors; and correcting one or more erroneous motion vectors by creating a homography from the one or more reliable motion vectors.

4. The method of claim 1 wherein the current frame comprises a matrix of blocks and the method further comprising computing a motion error probability of each one or more non-overlapped blocks.

5. The method of claim 1 further comprising computing a temporal average weight of each pixel in the current frame.

6. The method of claim 5 wherein the computing the temporal average weight of a given pixel includes determining a noise variance of the given pixel.

7. The method of claim 5 further comprising using the temporal average weight of each pixel to average the one or more motion-compensated previous frames and the one or more motion-compensated subsequent frames.

8. The method of claim 1 wherein restoring the blurred content in the current frame comprises restoring a mean value in block-level resolution of the current frame and, after, performing pixel level restoration of the current frame.

9. The method of claim 8, further comprising using temporal data blocks to coarsely detect errors in estimation of both motion and noise, and calculating weights using fast convolution operations and a likelihood function.

10. The method of claim 1, further comprising determining a noise variance for each pixel in the current frame, and using the noise variance for each pixel to perform the spatial filtering of the current frame.

11. The method of claim 1, further comprising a deblocking step that examines first motion vectors of adjacent blocks to determine if a motion vector discontinuity exists creating a sharp edge and indicating a blocking artifact has been created; then it analyzes high frequency behavior by comparing how much an edge is powerful compared to a reference frame, and removing the faulty high frequency edges.

12. A computing system for filtering noise from video data, the computing system comprising:
a processor;
memory for storing executable instructions and a sequence of frames of a video;
the processor configured to execute the executable instructions to at least perform:
applying time-domain filtering on a current frame of a video using one or more motion-compensated previous frames and one or more motion-compensated subsequent frames;
restoring blurred content in the current frame; and
applying spatial filtering the current frame to remove residual noise resulting from the time-domain filtering.

13. The computing system of claim 12 wherein the processor is configured to further estimate and compensate one or motion vectors obtained from one or more previous frames and one or more subsequent frames, to generate one or more motion-compensated previous frames and one or more motion-compensated subsequent frames.

14. The computing system of claim 13 wherein the process is configured to at least: identify one or more reliable motion vectors; and correct one or more erroneous motion vectors by creating a homography from the one or more reliable motion vectors.

15. The computing system of claim 12 wherein the current frame comprises a matrix of blocks and the processor is further configured to at least compute a motion error probability of each one or more non-overlapped blocks.

16. The computing system of claim 12 wherein the processor is further configured to at least compute a temporal average weight of each pixel in the current frame.

17. The computing system of claim 16 wherein the computing the temporal average weight of a given pixel includes determining a noise variance of the given pixel.

18. The computing system of claim 16 wherein the processor is further configured to at least use the temporal average weight of each pixel to average the one or more motion-compensated previous frames and the one or more motion-compensated subsequent frames.

19. The computing system of claim 12 wherein restoring the blurred content in the current frame comprises the processor restoring a mean value in block-level resolution of the current frame and, afterwards, performing pixel level restoration of the current frame.

20. The computing system of claim 19, further comprising using temporal data blocks to coarsely detect errors in estimation of both motion and noise, and calculating weights using fast convolution operations and a likelihood function.

21. The computing system of claim 12 wherein the processor is further configured to at least determine a noise variance for each pixel in the current frame, and using the noise variance for each pixel to perform the spatial filtering of the current frame.

22. The computing system of claim 12, further comprising a deblocking step that examines first motion vectors of adjacent blocks to determine if a motion vector discontinuity exists creating a sharp edge and indicating a blocking artifact has been created; then it analyzes high frequency behavior by comparing how much an edge is powerful compared to a reference frame, and removing the faulty high frequency edges.

23. The computing system of claim 12 comprising a body housing the processor, the memory, and a camera device.

24. A computer readable medium stored on a computing system, the computer readable medium comprising computer executable instructions for filtering noise from video data, the instructions comprising instructions for:
applying time-domain filtering on a current frame of a video using one or more motion-compensated previous frames and one or more motion-compensated subsequent frames;
restoring blurred content in the current frame; and
applying spatial filtering to the current frame to remove residual noise resulting from the time-domain filtering.
